(19) United States
(12) Patent Application Publication
(10) Pub. No.: US 2007/0281788 A1
(43) Pub. Date: Dec. 6, 2007

(54) Method and apparatus for conducting a ring-in game

(76) Inventors: Mark Olmstead, Denton, TX (US); Johnney R. Weaver, Weatherford, TX (US)

Correspondence Address: LAW OFFICES OF JAMES E. WALTON, PLLC, 1169 N. BURLESON BLVD., SUITE 107-328, BURLESON, TX, 76028, US

(21) Appl. No.: 11/478,429

(22) Filed: Jun. 29, 2006

Related U.S. Application Data
(63) Continuation-in-part of application No. 11/437,217, filed on May 19, 2006.

(51) Int. Cl. G06F 19/00

(52) U.S. Cl. 463/41

(57) ABSTRACT

A wireless communications device for use in a sweepstakes network is capable of being invited to participate in a ring-in game, via a communication system. The wireless communications device includes a memory capable of storing an electronic personal identification number associated with the ring-in game, an electronic personal identification module associated with the memory capable of maintaining the electronic personal identification number in the memory of the wireless communications device and a main processor associated with the memory capable of communicating with the communication system, wherein the main processor receives an invitation to participate in a ring-in game.

### CROSS-REFERENCE TO RELATED APPLICATION

This application is a continuation-in-part (CIP) of U.S. patent application Ser. No. 11/437,217, filed on 19 May 2006 and entitled “METHOD AND APPARATUS FOR CONDUCTING A RING-IN GAME”. The disclosure of related patent application Ser. No. 11/437,217 is hereby incorporated by reference into the present disclosure as if fully set forth herein.

This application contains technical disclosure in common with U.S. patent application Ser. No. 11/320,232, filed on 27 Dec. 2005 and entitled “METHOD AND APPARATUS FOR CONDUCTING A SWEEPSTAKES”.

### BACKGROUND

1. Field of the Invention

The present invention relates to a method and apparatus for conducting a ring-in game. In particular, the present invention relates to a method and apparatus for conducting a ring-in game in which a user purchases valuable goods and services unrelated to a ring-in game, and as a promotional bonus, the user is provided with an optional entry into a first ring-in game and a corresponding number of optional entries into other ring-in games.

2. Description of Related Art

Sweepstakes, raffles, and lotteries have been around for centuries. People enjoy the experience of entering a sweepstakes and hoping to win the “grand” prize. In most sweepstakes, the participant purchases a ticket, or entry, for a nominal amount of money in exchange for a chance to win prizes that are valued significantly higher than the cost of the ticket. Most often, the odds of the participant of winning the best prizes are very high. However, to entice new participants to play, to keep participants interested in playing the sweepstakes, or to entice the participants to play the sweepstakes again, prizes having nominal values close to or below the cost of the entry are often awarded. The participant's odds of winning these nominally valued prizes are typically close to 1:1.

Although the sweepstakes industry is heavy regulated, it remains very large and lucrative. Indeed, with the advent in recent years of prepaid vouchers, such as prepaid gasoline cards, prepaid credit cards, and prepaid phone cards, new games of chance and methods of conducting sweepstakes have been developed. For example, one of these new games of chance involves the purchase of a $1.00 “emergency” prepaid phone card that provides about one minute of telephone airtime and an entry in a game of chance. In this example, a person inserts currency into a game terminal and, in return, receives a corresponding number of $1.00 “emergency” prepaid phone cards.

The prepaid phone cards used in these games are typically multi-layered or folded pieces of paper or cardboard that are preprinted and stored on a roll inside the game terminal. The prepaid phone cards used in these games are “read-only” devices that can only be read by card readers in the game terminal. Once these prepaid phone cards are printed, the data cannot be changed and no more data can be added. Certain indicia is printed on each $1.00 prepaid phone card, including a personal identification number (PIN) that is required to use the prepaid phone cards from any telephone, bar codes, and other graphical indicia that instruct the game terminal on what images to display and what prizes, if any, have been won. Thus, the “winning” and “losing” prepaid phone cards are predetermined.

One problem with these games is that each game terminal is a separate stand-alone machine. Because the prepaid phone cards are preprinted, there is no need or capability to interconnect or network the game terminals together. This greatly reduces the number, type, and style of games that can be played. In other words, the participants cannot choose between different games, cannot compete against each other on different game terminals, and cannot play the game over computer networks, such as the Internet. In addition, the game terminals cannot be monitored and maintained from a remote location over a computer network.

Another problem with these types of games of chance is that most participants purchase the prepaid phone card for the sole purpose of entering the game of chance, not to use the prepaid phone cards to buy telephone airtime. When the participant purchases the prepaid phone cards, he participates in the game of chance, whether he wants to or not. Because people only purchase these “emergency” prepaid phone cards to participate in the game, the regulatory authorities in many jurisdictions have determined that these games are illegal lotteries. The reasoning is that, because the prepaid phone card has a nominal value, the participants are giving consideration merely to play a game of chance, not to buy and use the prepaid phone cards to make telephone calls. This is evidenced by the fact that these $1.00 prepaid phone cards are often found unused in trash receptacles outside of establishments that sell such prepaid phone cards and offer such games of chance.

Although there have been great strides made in the area of conducting sweepstakes, many shortcomings remain.

### SUMMARY OF THE INVENTION

There is a need for a game in which a user receives one or more free game entries that can be used to participate in one or more ring-in type games.

Therefore, it is an object of the present invention to provide an apparatus and method for conducting a ring-in game in which a user is provided with optional entries into a first ring-in game and a corresponding number of optional entries into other ring-in games.

This object is achieved by providing a wireless communications device capable of being invited to participate in a ring-in game via a communication system. The wireless communications device comprises a memory capable of storing an electronic personal identification number associated with the ring-in game, an electronic personal identification module associated with the memory capable of maintaining the electronic personal identification number in the memory of the wireless communications device, and a main processor associated with the memory capable of communicating with the communication system, wherein the main processor receives an invitation to participate in a ring-in game.

It is an another object of the present invention to provide a network for conducting a ring-in game comprising a wireless communications device capable of being invited to participate in the ring-in game via the network, a memory capable of storing an electronic personal identification number associated with the ring-in game, an electronic personal identification module associated with the memory capable of maintaining the electronic personal identification number in the memory of the wireless communications device and a main processor associated with the memory capable of communicating with the communication system, wherein the main processor receives an invitation to participate in a ring-in game.

It is still another object of the present invention to provide a method for conducting a ring-in game including providing an electronic personal identification number to at least one wireless communications device capable of being invited to participate in the ring-in game via a communication system, providing readable and writeable digital storage means for storing digital data related to the ring-in game, providing a plurality of wireless networks capable of data communication with the at least one wireless communications device, and providing at least one entry into the ring-in game.

According to another embodiment of the present invention, the method for conducting a ring-in game includes playing the ring-in game on the at least one wireless communications device, in response to an invitation to join the ring-in game via one of the plurality of wireless networks, and displaying the results of the ring-in game on a display of the at least one wireless communications device.

These and other advantages and features of the present invention will become readily apparent to those skilled in the art upon examination of the subsequent detailed description and accompanying drawings. Accordingly additional advantages and features of the present invention and the scope thereof are pointed out with particularity in the claims and form a part hereof.

### DESCRIPTION OF THE DRAWINGS

The novel features believed characteristic of the invention are set forth in the appended claims. However, the invention itself, as well as a preferred mode of use, and further objectives and advantages thereof, will best be understood by reference to the following detailed description when read in conjunction with the accompanying drawings, wherein:

FIG. 1 is a graphical representation of an exemplary ring-in sweepstakes network, according to one embodiment of the present invention;

FIG. 2 is a graphical representation of the wireless communications device of FIG. 1, according to one embodiment of the present invention; and

FIG. 3 is a flowchart illustrating the operation of an exemplary ring-in sweepstakes game, according to one embodiment of the present invention.

### DETAILED DESCRIPTION OF THE PREFERRED EMBODIMENT

Reference will now be made to the following detailed description of the exemplary embodiments of the present invention. Those skilled in the art will recognize that the present invention provides many inventive concepts and novel features, that are merely illustrative, and are not to be construed as restrictive. Accordingly, the specific embodiments discussed herein are given by way of example and do not limit the scope of the present invention.

The present invention involves a method and apparatus for conducting a ring-in sweepstakes game in which a user purchases valuable goods and services unrelated to the ring-in sweepstakes game and in return, as a promotional bonus, the user is provided an entry into a ring-in sweepstakes game and may also be provided a corresponding number of entries into various other promotional sweepstakes.

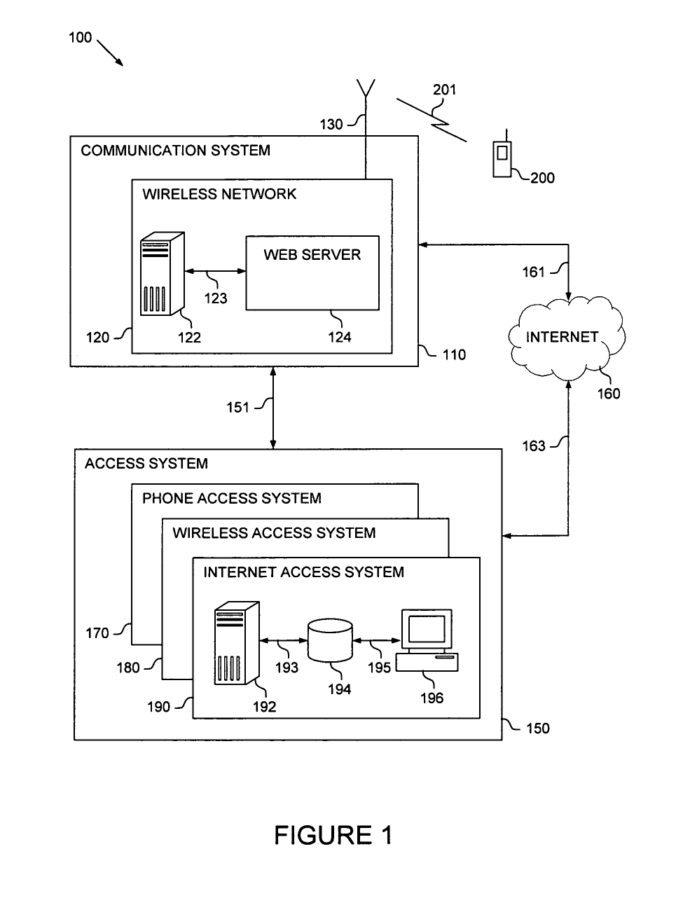

Referring now to FIG. 1 in the drawings, a preferred embodiment of a ring-in sweepstakes network 100 according to the present invention is illustrated. Ring-in sweepstakes network 100 comprises a communications system 110, an access system 150, an Internet 160, and a wireless communications device 200. Communication system 110 comprises a wireless network 120; including a database server 122 networked to a web server 124 via a communication link 123 and an antenna array 130. In addition, communication system 110 is networked via communication link 151 to access system 150, and networked to Internet 160 via communication link 161.

Wireless communications device 200 is capable of accessing communication system 110 via radio frequency (RF) communication link 201 and/or via Internet 160 through communication link 161, as described in more detail below. RF communication link 201 provides the operable connection between communication system 110 and wireless communications device 200. As described below in more detail, wireless communications device 200 may be any wireless communication device, including, but not limited to, conventional cellular telephones, paging devices, personal digital assistant devices, text-message transmission devices, portable computers, or any other like device capable of wireless communication.

It should be understood that the present invention is not limited to only mobile wireless communication devices. Other types of communication devices may be used, including fixed (i.e., stationary) communication devices or terminals. For the sake of simplicity, only a mobile wireless communications device is shown and discussed hereafter. However, for the purposes of defining the scope of the claims of the present invention, the term “wireless communications device” and any other term used to denote a device that communicates with communication system 110, should be construed broadly to include both mobile and stationary communication devices. In addition, for simplicity and clarity, only a single communication system and a single wireless communications device is shown and described in ring-in sweepstakes network 100, as is unique to the present invention or necessary for an understanding of the present invention. However, one or more communication systems may be comprise multiple wireless networks, each of which communicates with a plurality of wireless communication devices.

In one embodiment of the present invention, selected data is periodically transferred back and forth between one or more communication systems via communication link 161, Internet 160, or any other communication link operable to transfer data between the one or more communication systems. For example, the one or more communication systems may provide for periodic polling to ensure that the one or more wireless networks always has enough bandwidth to communicate with the plurality of wireless communication devices and has enough computing capacity to continuously conduct and control the ring-in sweepstakes games.

Wireless connectivity between wireless communications device 200 and Internet 160 is provided by communications system 110 through, for example, antenna array 130 of wireless network 120. Those skilled in the art will recognize that the complete structure and operation of wireless network 120 and other components within communications system 110 are not shown or described. The present invention may be employed in conjunction with known wireless communication networks and other components, and only so much of those components as is unique to the present invention or necessary for an understanding of the present invention are shown and described.

Access system 150 comprises one or more access systems, such as, for example, phone access system 170, wireless access system 180, and Internet access system 190. The scope of the present invention, however, encompasses other additional or alternative access systems within access system 150. In addition, access system 150 is networked via communication link 151 to communication system 110 and networked to the Internet 160 via communication link 163. In the illustrated embodiment of the present invention, Internet access system 190 comprises database server 192, database 194, and management terminal 196. In addition, database server 192 is networked via communication link 193 to database 194 which is networked via communication link 195 to management terminal 196. Additionally, phone access system 170 and wireless access system 180 each may comprise a database server, a database, and a management terminal, similar to those shown and described in relation to Internet access system 190.

In addition or as an alternative, one or more communication systems 110 may be networked together, and may be networked to one or more access systems 150, by communication link 151 or communication links 161 and 163 via Internet 160. Communication links 123, 151, 161, 163, 193 and 195 may comprise modems, telephone lines, the Internet, satellites, wireless connections, or any combination thereof for sending and receiving digital data and signals. Communication links 123, 151, 161, 163, 193 and 195 provide a fast, efficient, reliable, and secure means for transferring radio frequency (RF) and digital data between and through communication system 110, access system 150 and Internet 160.

It will be appreciated that in alternate embodiments the functions and operations of communication system 110, access system 150, and Internet 160 may be combined in different configurations into one or more networks and/or one or more servers located either at communication system 110 or remote from communication system 110.

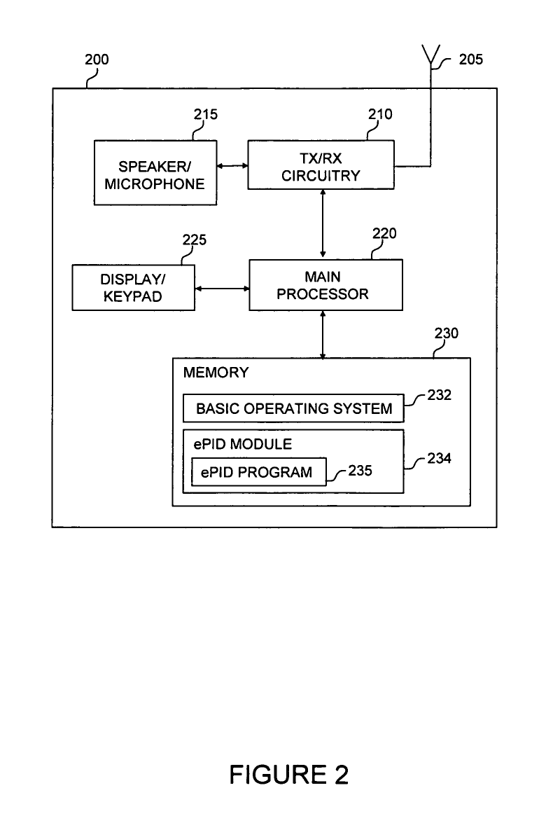

Referring now to FIG. 2 in the drawings, an exemplary wireless communications device 200, according to the present invention is illustrated in greater detail. Wireless communications device 200 comprises an antenna 205, a transmit/receive (TX/RX) circuitry 210, a speaker/microphone 215, a main processor 220, a display/keypad 225, and a memory 230. Memory 230 comprises a basic operating system (OS) program 232 and an electronic personal identification (ePID) module 234. The ePID module 234 comprises an ePID program 235, which is a subroutine that provides a digital storage means for electronically tracking and storing electronic personal identification in ePID module 234.

TX/RX circuitry 210 receives from antenna 205 an incoming signal transmitted by for example, antenna array 130 of communication system 110 or by a wireless network provider via Internet 160. TX/RX circuitry 210 processes and sends the incoming signal to the speaker (i.e., voice data) or to main processor 220 for further processing (e.g., web browsing, interactive video game data). Likewise TX/RX circuitry 210 receives analog or digital voice data from the microphone or other outgoing data (e.g., web data, e-mail, interactive video game data) from main processor 230. TX/RX circuitry 210 transmits a radio frequency (RF) signal that is transmitted via antenna 205.

In one advantageous embodiment of the present invention, main processor 220 is a microprocessor or microcontroller. Memory 230 is coupled to main processor 220. According to an advantageous embodiment of the present invention, part of memory 230 comprises a random access memory (RAM) and another part of memory 230 comprises a Flash memory, which acts as a read-only memory (ROM).

Main processor 220 executes basic operating system (OS) program 232 stored in memory 230 in order to control the overall operation of wireless communications device 200. For example, main processor 220 controls the reception of signals and the transmission of signals by TX/RX circuitry 210, in accordance with well-known principles. Main processor 220 is capable of executing other processes and programs resident in memory 220; including ePID module 234 and ePID program 235. Main processor 230 may move data into or out of memory 230, as required by an executing process. Main processor 220 is also coupled to display/keypad 225. The user of wireless communications device 200 uses the keypad to enter data into wireless communications device 200. The display may be a liquid crystal display capable of rendering text and/or at least various graphics from communication system 110 and/or Internet 160. Alternate embodiments may use other types of displays.

In a preferred embodiment of the present invention, ePID module 234 is primarily responsible for establishing and maintaining an electronic personal identification number (ePIN) in memory 230. Before ePID module 234 can be used to participate in a ring-in sweepstakes game, ePID module 234 must be activated. Activation of ePID module 234 is performed by establishing communication with communication system 110 and writing an electronic personal identification number (ePIN) into memory 230. As discussed above, ring-in sweepstakes network 100 may comprise one or more communication systems operable to communicate with a plurality of wireless communication devices. Accordingly, it is not necessary that ePID module 234 be used with the same communication system 110 at which ePID module 234 was activated. Should the user choose to participate in a ring-in sweepstakes game, ePID module 234 of wireless communications device 200 may be used at any time, any location, or with any communication system 110, provided the ePIN associated with ePID module 234 has not expired (for instances in which the ePIN associated with ePID module 234 includes an expiration date).

It is understood that wireless communications device 200 is given by way of example and that for simplicity and clarity, only so much of the construction and operation of wireless communications device 200 as is unique to the present invention or necessary for an understanding of the present invention is shown and described. Moreover, although wireless communications device 200 is shown as having an ePID module 234 in memory 230, in an alternate embodiment wireless communications device 200 comprises the ability to transfer the ePIN into the random access memory associated with memory 230. In another alternate embodiment, the ring-in sweepstakes game is capable of being loaded into the random access memory associated with memory 230 and is further capable of being displayed on the display of wireless communications device.

In addition, wireless network 120 manages the electronic personal identification numbers (ePIN's) associated with the ring-in sweepstakes game, manages the ring-in sweepstakes game entries, maintains and provides accounting information for communication system 110, contains the ring-in sweepstakes play information, and transmits the ring-in sweepstakes game entries to wireless communications device 200 for display to the user.

In a preferred embodiment of the present invention, web server 124 of wireless network 120 allows the user of wireless communications device 200 to by-pass playing a ring-in sweepstakes game and instantly validate any predetermined winnings on ePID module 234. The user of wireless communications device 200 simply communicates with wireless network 120 and selects to validate any predetermined wining points on ePID module 234, wireless communication device 200 displays the number of wining points on the display and writes updated digital data to ePID module 234.

In another preferred embodiment of the present invention, web server 124 of wireless network 120 allows the user of wireless communications device 200 to purchase additional access time. The user of wireless communications device 200 simply communicates with wireless network 120 and selects the amount of access time to be added to ePID module 234, it is not necessary that all access time on ePID module 234 be used up before more access time is added, or another words, before ePID module 234 is recharged. With each recharge of additional access time, ePID module 234 is updated with a corresponding entry into a ring-in sweepstakes game and may also be provided a corresponding number of entries into various other promotional sweepstakes.

In an alternate embodiment of the present invention, a network provider, such as for example a wireless network provider of communication system 110, may provide its members, users of wireless communications device 200, with ePIN's and/or recharge ePID module 234 with a predetermined number of entries into a ring-in sweepstakes game, at a predetermined time. For example, at the execution of a contract for network services, upon receipt of payment for monthly services, or at any other predetermined times, a network provider may provide its members with an ePIN and/or recharge ePID module 234 with a predetermined number of entries into a ring-in sweepstakes game. In addition, or as an alternative, a wireless network provider, of wireless communications device 200, may allow its members to redeem ePIN's and/or recharge ePID module 234 in exchange for rollover minutes or redeem for any other type of promotional offer made by the wireless network provider. In addition, a wireless network provider, of wireless communications device 200, may provide its members with ePIN's and/or recharge ePID module 234 as a reward for access time purchased at either fixed time increments or excess time above the contractually agreed amount of time for network services.

Accordingly, ePID module 234 of wireless communications device 200 may be used for: (1) prepaid access time including phone time, Internet access time, wireless network access time and any other like access time; (2) purchasing of products and merchandise from the network provider or through Internet 160; (3) generating free sweepstakes entries into the ring-in sweepstakes game; (4) awarding promotional ring-in sweepstakes game points; and (5) redeeming winning points from the network provider or through Internet 160.

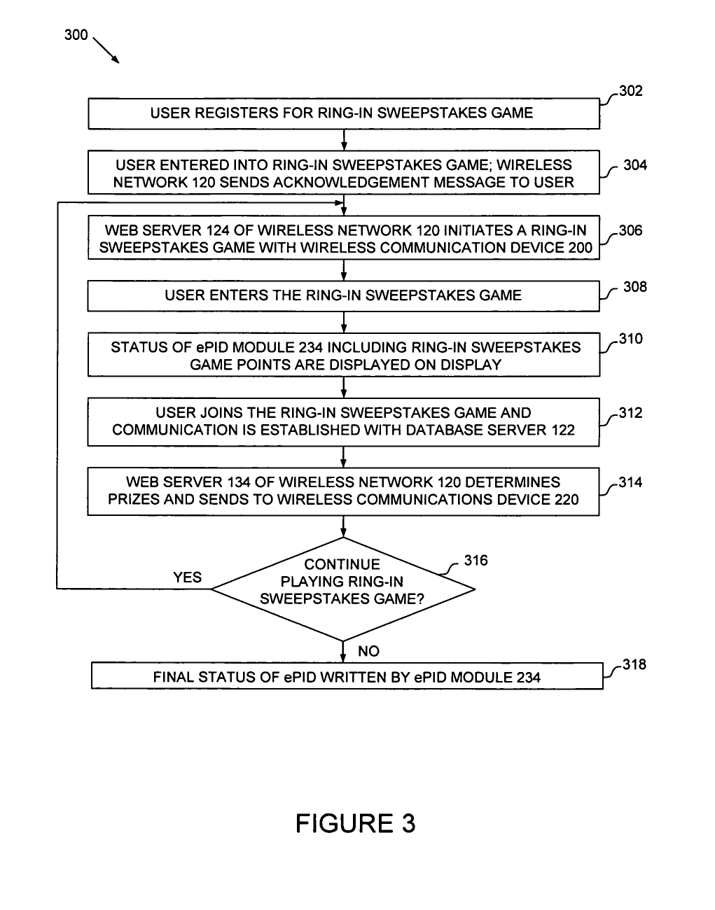

FIG. 3 is a high-level flow diagram 300, illustrating the operation of an exemplary ring-in sweepstakes game according to one embodiment of the present invention. Participation in the ring-in sweepstakes game begins with an initiation step 302, in which the user registers for the ring-in sweepstakes game. The user of wireless communications device 200 may purchase valuable goods and services unrelated to the ring-in sweepstakes game and in return, as a promotional bonus, the user may be provided an entry into a ring-in sweepstakes game and may also be provided a corresponding number of entries into various other promotional sweepstakes. In addition or as an alternative, the user of wireless communications device 200 may be a member of wireless network 120 and the valuable goods and services unrelated to the ring-in sweepstakes game may be the payment for monthly network services, rollover minutes, or access time purchased at either fixed time increments or excess time above the contractually agreed amount of time for network services.

In an alternate embodiment of the present invention, a user of wireless communications device 200 may be provided an entry into a ring-in sweepstakes game including an ePIN and/or a corresponding number of entries into various other promotional sweepstakes on a purely promotional basis. For example, a fast food chain restaurant may provide a promotional sweepstakes to its customers or potential customers as part of a marketing program. Although, a fast food chain restaurant has been described as an example, the present invention contemplates any suitable type of store or entity capable of providing a promotional ring-in sweepstakes game.

At step 302, the user registers for the ring-in sweepstakes game via a website, for example, “www.ring-in.com”, in which the user also includes a valid wireless communications device phone number or other valid communication device access number. In addition or as an alternative, the user may register for the ring-in sweepstakes game via a website and include an email address, a text message address, a “land-line” phone number, or any other address or phone number as contact information for the ring-in sweepstakes game. The website for registering for the ring-in sweepstakes game may be maintained in web server 124 of wireless network 120, or any other website hosting service, according to particular needs.

In an alternate embodiment of the present invention, the user may register for the ring-in sweepstakes game at a participating promotional sweepstakes store. In this manner, the user may enter a store participating in a promotional sweepstakes and register for the ring-in sweepstakes game via a computing device located in the store or via the user's wireless communications device in the store. In addition or as an alternative, the user may call a sweepstakes number or visit a website to register for the ring-in sweepstakes game either at the store participating in the promotional sweepstakes or outside at some other location.

Then, at step 304, wireless network 120 acknowledges the user registration for the ring-in sweepstakes game in process step 302 or, if the user is already registered for the ring-in sweepstakes game, wireless network 120 sends an acknowledgment message, such as for example, a text message, to the user through the Internet via communications link 161. Although a text message is described as performing the acknowledgement of the user registration for the ring-in sweepstakes game, the present invention contemplates any suitable message or combination of messages sent to the user as an acknowledgement message. For example, the acknowledgement of the user registration for the ring-in sweepstakes game may be made via a short message service (SMS), a multimedia messaging service (MMS), email, voice message, or the like.

Next, at step 306, web server 124 of wireless network 120, initiates a ring-in sweepstakes game with wireless communications device 200, such as for example Texas Hold-em poker sweepstakes game, or any other type of sweepstakes game. Web server 124 rings wireless communications device 200 to invite the user to participate in the ring-in sweepstakes game. The ring-in may cause wireless communications device to ring and provide a pre-recorded voice message, provide a text message, initiate ePID module 234 to display an invitation message on the display, or any other type of action taken by wireless communications device 200 to invite the user of wireless communications device 200 to join the ring-in sweepstakes game. In a preferred embodiment of the present invention, the user of wireless communications device 200 may be given a predetermined time period in which to respond to the invitation to join the ring-in sweepstakes game. In addition or as an alternative, the ring-in may provide the user with information about the type of ring-in sweepstakes game, the duration of the sweepstakes game, and the odds of winning the ring-in sweepstakes game.

In an alternate embodiment of the present invention, the user of wireless communications device 200 may be provided with an option to participate in the ring-in sweepstakes game via another communication device other than wireless communications device 200. As an example and not by way of limitation, the user of wireless communications device 200 may participate in the ring-in sweepstakes game via a desktop computer, a laptop computer, or any other type of access terminal operable to play the ring-in sweepstakes game. Accordingly, if the user of wireless communications device 200 chooses to utilize another access terminal to play the ring-in sweepstakes game, then the ring-in may provide a password or code to the user of wireless communications device 200, including a predetermined time period in which to respond to the invitation to join the ring-in sweepstakes game, via the other access terminal. For example, the user of wireless communications device 200 may utilize a desktop computer to access a website via the Internet or other network system, associated with the ring-in sweepstakes game, including logging into the ring-in sweepstakes game using the given password or code.

Next, at step 308, the user of wireless communications device 200 responds to the invitation to join the ring-in sweepstakes game, in an appropriate time frame and enters the ring-in sweepstakes game. Then in step 310, ePID module 234 is used by wireless communications device 200 and ePID program 235 to display the status of the quantity of promotional sweepstakes points. During step 310, selected images are displayed at selected portions of the display of wireless communications device 200 at selected times. As set forth above, the number of minutes of access time currently available on ePID module 234 may be displayed on a first portion of the display, the number or amount of promotional sweepstakes entries available on ePID module 234 may be displayed on a second portion of the display, the number or amount of credits or “wins” currently available on ePID module 234 may be displayed on a third portion of the display, and the status of the current ring-in sweepstakes game in progress may be displayed on a fourth portion of the video display.

Although a ring-in sweepstakes game has been shown and described with a single user of wireless communications device 200, the present invention contemplates any suitable type or number of users. For example, web server 124 of wireless network 120, may initiate a ring-in sweepstakes game with multiple wireless communications devices. The ring-in sweepstakes game may be initiated with a series of qualification rounds inviting multiple users to join in the ring-in sweepstakes game. In addition or as an alternative, web server 124 of wireless network 120 may invite the winners of the qualification rounds to join multiple playoff rounds and even a championship round. In this manner, web server 124 of wireless network 120 may initiate multiple ring-in sweepstakes games involving multiple users.

In an alternate embodiment of the present invention, the ring-in sweepstakes game may be initiated by wireless communications device 200. In this manner, wireless network device 200 initiates the ring-in sweepstakes game and may invite web server 124 of wireless network 120 to play (i.e. the user of wireless communications device 200 plays against the computer), or any wireless communications device registered for the ring-in sweepstakes game (i.e. the user of wireless communications device 200 plays against other users on a peer to peer network).

Although an example sweepstakes game has been described as a Texas Hold-em poker sweepstakes game, the present invention contemplates any suitable type or style of ring-in sweepstakes game. For example, web server 124 of wireless network 120, may initiate a trivia game, an electronic card game, an electronic board game, a bingo game, a promotional game, or any other like game.

In a preferred embodiment of the present invention, an entity may provide a promotional sweepstakes to its customers or potential customers. In such an embodiment, the entity may work in conjunction with communication system 110 to initiate a ring-in sweepstakes game with multiple wireless communications devices. An example ring-in sweepstakes game may be for example, a Texas Hold-em poker sweepstakes game comprising a series of qualification rounds wherein multiple users are invited to play against wireless network 120. Accordingly, the winners of the qualification rounds are invited to join multiple playoff rounds and even a championship round. The user who wins the championship round may be provided the opportunity to play in a “world Texas Hold-em poker” game, as an entrant at least sponsored in part by the entity. In an alternative of the present invention, the ring-in sweepstakes game may be a trivia game, wherein web server 124 of wireless network 120, may initiate a ring-in sweepstakes trivia game to extract marketing data of users and store the extracted data in database server 122.

In another alternate embodiment of the present invention, web server 124 of wireless network 120, may initiate a ring-in sweepstakes game based on a time based calculation or the geographical location of wireless communications device 200. For example, if wireless communications device 200 is located in a particular time zone, communication system 110 may initiate a ring-in game just before an eating time (i.e. breakfast time, lunch time, dinner time, happy hour time, or the like). In this manner, instead of winning points, the user of wireless communications device 200 may be provided with an electronic coupon. Such as for example, a discounted or free hamburger, buy one get one free dinner, or the like. In another example, if wireless communications device is located near a participating promotional entity, communication system 110 may initiate a ring-in game and the winning points may be redeemable for a discount or free item at the specific participating promotional entity location.

The process continues with step 312, in which the user joins the ring-in sweepstakes game. This is done by selecting one of the designated graphical images on the display of wireless communications device 200, depicting the desired ring-in sweepstakes game, or by depressing one or more keys associated with keypad 225. Initiation of the game causes main processor 220 and ePID program 235 of ePID module 234 of wireless communications device 200 to send signals and/or data over RF communication link 201 to web server 124 of wireless network 120. Also, after initiating the game, either main processor 220 or ePID program 235 of ePID module 234 in communication with web server 124 of wireless network 120 will cause the display of wireless communications device 200 to initiate a simulation of the ring-in sweepstakes game being played. For example, if a Texas Hold-em poker sweepstakes game had been initiated; graphical images or movies may be displayed to simulate the poker game being played at preprogrammed intervals. Likewise, if a trivia sweepstakes game had been initiated; graphical images or movies may be displayed to simulate the trivia game, including the ability to respond to the trivia questions.

Then, in calculation step 314, web server 124 of wireless network 120 calculates and determines how many, if any, prizes are to be awarded for the play associated with the ring-in sweepstakes game.

In a preferred embodiment of the present invention, ePID module 234 is not preprogrammed at the time of sale of valuable goods and services unrelated to the ring-in sweepstakes game and/or the registration of the ring-in sweepstakes game with any winning or losing combination of data. The user must choose to participate in the ring-in sweepstakes game and submit an entry via a website in order to play the ring-in sweepstakes game and win any prizes. Accordingly, the calculations and determinations of prizes are conducted by web server 124 of wireless network 120 and is a ring-in sweepstakes game in response to entries made by users from wireless communications devices. In an alternate embodiment of the present invention, ePID module 234 is preprogrammed at the time of sale of valuable goods and services unrelated to the ring-in sweepstakes game and/or the registration of the ring-in sweepstakes game with a predetermined winning and losing combination of data. Thus, the user may choose to participate in the ring-in sweepstakes game or the user may merely choose to communicate with wireless network 120 to validate any wining prizes. Accordingly, the calculations and determinations of prizes are predetermined and preprogrammed on ePID module 234 at the time of activation.

In the preferred embodiment of the present invention, after web server 124 of wireless network 120 calculates and determines whether a prize has been won, the process continues, in which web server 124 of wireless network 120 transmits selected digital signals and data to the appropriate wireless communications device 200 via RF communication link 201. Once the data has been received by wireless communications device 200, main processor 220 and ePID program 235 of ePID module 234 may cause corresponding audio and video messages, such as “You're a Winner!”, “You're Advanced to the Next Round!”, or “You've Won a Hamburger!” to be displayed on the display of wireless communications device 200. In addition, main processor 220 and ePID program 235 of ePID module 234 may activate graphics and the speaker to enhance the experience of playing the ring-in sweepstakes game.

Although an example action has been described to activate graphics and the speaker of wireless communications device 200, the present invention contemplates any suitable type of action taken by wireless communications device 200 to alert the user that a prize has been won. For example, main processor 220 and ePID program 235 of ePID module 234 may cause an electronic coupon to be displayed on wireless communication device 200. The user of wireless communication device 200 may print out the electronic coupon and redeem it at a participating entity, utilize the electronic coupon directly at a participating entity, or the electronic coupon may be emailed to the user via communication system 110 and Internet 160.

After each ring-in sweepstakes game session, the process continues with an inquiry step 316, in which a determination is made as to whether the user may advance to a next round and/or if the user wishes to continue to play the ring-in sweepstakes game. If the user decides to continue to play the the ring-in sweepstakes game, the process continues back to step 306, in which the user awaits web server 124 of wireless network 120 to initiate the next round or another ring-in sweepstakes game. On the other hand, if the user decides not to continue playing the ring-in sweepstakes game, or if the user did not advance to the next round, the process ends with step 318.

Finally, as represented by step 318, when the user decides to end the ring-in sweepstakes game, the user may depress a portion of the display that is displaying a graphical image depicting end ring-in sweepstakes game or the user may use the keypad of wireless communications device 200, thereby sending corresponding signals and data to ePID module 234 identifying that the user no longer wishes to participate in the ring-in sweepstakes game. This causes ePID program 235 on wireless communications device 200 to write the final status to ePID module 234. Accordingly, ePID module 234 may then be used to access time for example to place telephone calls or access Internet 160 via communication system 110.

It is understood that other operations can be implemented within the scope of the invention. It is also understood that the sequence of the operation shown can be varied without departing from the scope or principles of the present invention.

It is apparent that an invention with significant advantages has been described and illustrated. Although the present invention is shown in a limited number of forms, it is not limited to just these forms, but is amenable to various changes and modifications without departing from the spirit thereof.

What is claimed is:

1. For use in a sweepstakes network, a wireless communications device capable of being invited to participate in a ring-in game via a communication system, the wireless communications device comprising:
a memory capable of storing an electronic personal identification number associated with the ring-in game;
an electronic personal identification module associated with the memory capable of maintaining the electronic personal identification number in the memory of the wireless communications device; and
a main processor associated with the memory capable of communicating with the communication system, wherein the main processor receives an invitation to participate in the ring-in game.

2. The wirelessy communications device according to claim 1, wherein the electronic personal identification number is associated with the purchase of goods and services unrelated to the ring-in game.

3. The wireless communications device according to claim 1, wherein the electronic personal identification number is associated with a promotional sweepstakes.

4. The wireless communications device according to claim 1, wherein a network provider of a user of the wireless communications device provides the user with a predetermined number of entries into the ring-in game.

5. The wireless communications device according to claim 1, wherein an entity provides a user of the wireless communications device with a predetermined number of entries into the ring-in game.

6. The wireless communications device according to claim 5, wherein the entity is an entity selected from the group consisting of:
a fast food chain restaurant;
a restaurant chain;
a home improvement store chain; and
a retail store chain.

7. The wireless communications device according to claim 5, wherein the user of the wireless communications device responds to the invitation to join the ring-in game and the main processor of the wireless communications device provides an electronic coupon to the user of the wireless communications device.

8. The wireless communications device according to claim 1, wherein the wireless communications device is a cellular telephone.

9. A network for conducting a ring-in game comprising:
a wireless communications device capable of being invited to participate in the ring-in game via the network;
a memory capable of storing an electronic personal identification number associated with the ring-in game;
an electronic personal identification module associated with the memory capable of maintaining the electronic personal identification number in the memory of the wireless communications device; and
a main processor associated with the memory capable of communicating with the communication system, wherein the main processor receives an invitation to participate in the ring-in game.

10. The network according to claim 9, further comprising:
a plurality of communication systems capable of data communication with at least one wireless communications device;
at least one wireless network capable of data communication with the plurality of communication systems and the at least one wireless communications device; and
at least one access system capable of data communication with the plurality of communication systems, the at least one wireless network, and the at least one wireless communications device.

11. The network according to claim 9, wherein the electronic personal identification number is associated with the purchase of goods and services unrelated to the ring-in game.

12. The network according to claim 9, wherein the electronic personal identification number is associated with a promotional sweepstakes.

13. The network according to claim 9, wherein a network provider of a user of the at least one wireless communications device provides the user with a predetermined number of entries into the ring-in game.

14. The network according to claim 9, wherein the at least one wireless network provides an instant validation of any predetermined wining points on the electronic personal identification module of the at least one wireless communications device.

15. The network according to claim 9, wherein an entity provides a user of the at least one wireless communications device with a predetermined number of entries into the ring-in game.

16. The network according to claim 15, wherein the wireless communications device further comprises:
readable and writeable means for accessing digital data associated with the electronic personal identification number;
means for playing the ring-in game; and
means for updating the electronic personal identification module with the ring-in game results;
wherein, upon playing at least one ring-in game, the user may redeem any winnings through an electronic coupon at any of the entities associated with the ring-in game.

17. The network according to claim 9, wherein the ring-in game is a Texas Hold-em poker game.

18. A method for conducting a ring-in game comprising the steps of:
providing an electronic personal identification number to at least one wireless communications device capable of being invited to participate in the ring-in game via a communication system;
providing readable and writeable digital storage means for storing digital data related to the ring-in game;
providing a plurality of wireless networks capable of data communication with the at least one wireless communications device;
providing at least one entry into the ring-in game;
playing the ring-in game on the at least one wireless communications device, in response to an invitation to join the ring-in game via one of the plurality of wireless networks; and
displaying the results of the ring-in game on a display of the at least one wireless communications device.

19. The method according to claim 18, further comprising the steps of:
providing means for recharging the electronic personal identification module via the plurality of wireless networks with additional entries into the ring-in game;
providing a corresponding number of electronic coupons to a user of the at least one wireless communications device for participating in the ring-in game.

20. The method according to claim 18, further comprising:
providing an invitation to the at least one wireless communications device based on the geographical location of the at least one wireless communications device.
